(19) United States
(12) Patent Application Publication
(10) Pub. No.: US 2018/0210191 A1
(43) Pub. Date: Jul. 26, 2018

(54) SUSPENSION SYSTEM OF OPTICAL ACTUATOR

(71) Applicant: Min Aik Technology Co., Ltd., Taoyuan City (TW)

(72) Inventors: Chi-Bin Lo, Taoyuan City (TW); King-Sheng Chao, Taoyuan City (TW); Ching-Hsuan Chuang, Taoyuan City (TW); Tung-Kai Wu, Taoyuan City (TW); Shih-Po Yeh, Taoyuan City (TW)

(21) Appl. No.: 15/415,891

(22) Filed: Jan. 26, 2017

(51) Int. Cl. G02B 26/08; G02B 7/02; G02B 13/16; G03B 21/14

(52) U.S. Cl. CPC G02B 26/0875; G03B 21/142; G02B 13/16; G02B 7/02

(57) ABSTRACT

A suspension system of an optical actuator is arranged such that an oscillation member of an actuator is mounted, in a movable manner, on a base, and the base comprises an assembly opening formed in a central portion thereof, the assembly opening being provided with a positioning seat on each of at least one diagonal bisection line. The oscillation member that comprises an optical lens is supported on the base by two flexible members so as to form a suspension system of an optical actuator. The two flexible members are each a plate-like structure and has two opposite side edges each formed with a shaped trough with a portion therebetween forming a bridge, and two sides of the bridge are corresponding to tangential lines of positioning curves of the shaped troughs.

### TECHNICAL FIELD OF THE INVENTION

The present invention relates to a suspension system of an optical actuator, and more particularly to one that comprises a structural design of a flexible member that is in the form of a spring ann to allow for more stable and more precise oscillation of an actuator so as to improve resolution and stability of image projection.

### DESCRIPTION OF THE PRIOR ART

Advanced optical projection systems are required to be not only compact in size but also high resolution of image projection, and also with reduced expense. Under such three conditions, a design of advanced optical projection systems, as illustrated in FIGS. 9 and 10, is such that an image from a micro chip panel 60 (such as digital micro-mirror device, DMD) is directed through a prism 70, an actuator 80, and a lens 90 to be projected to a screen (not shown). The projected light of an image, during the travel thereof, passes through lenses arranged inside the actuator and is subjected to fast repeated vibration or oscillation (to change the location of projection) by the actuator 80 so as to increase the resolution thereof through repeated change of the location of the image.

A commonly adopted structure of conventional actuators 80 is illustrated in FIGS. 11, 12, and 13 and comprises a base 81 with a rectangular assembly opening 801 formed in a center of the base 81. The assembly opening 801 is provided with a bearing 82 and a rotary shaft 83 at each of two opposite sites. An oscillation member 84 is arranged between the two rotary shafts 83. The oscillation member 84 comprises a carrier table 841 and a lens 842. When the actuator is acted upon by an electromagnetic effect (not illustrated) induced nearby, the oscillation member 84 is driven such that the oscillation member 84 undergoes regular up and down oscillation on two sides with an axis L1 between the two groups of bearing 82 and rotary shaft 83 serving as a base line in order to change the location of projection. This is one of the most commonly adopted measures.

However, structurally, the conventional actuator 80 suffers the following disadvantages:

(1) Such a prior art device uses the groups of bearing 82 and rotary shaft 83 as support points. However, clearance may exist between the bearing 82 and the rotary shaft 83 so that during fast up and down oscillations on the two sides, the locations of the support points are shifted up and down due to the clearance, or the rotary shaft 83 may axially shifted within the bearing, both making the projection location of light constantly varying due to the clearance and the axial shifting, and thus resulting in unpredictable errors and instability of resolution.

(2) With the bearings 82 of the actuator 80 provided on the base 81, it is not possible to reduce the size of the device or thin the device and this imposes undesired limitation to the size of a final product with future improvement of later product being potentially impossible.

(3) Using bearings 82 and rotary shafts 83 to serve as support points increases the cost of the actuator 80 so that the manufacture cost is high and additional high cost is required for maintenance and replacement of worn parts.

In addition, it is also known to use rectangular spring plates to serve as a torsion axle as a substitute of the solution that involves bearings as support points. This reduces the cost. However, the rectangular spring plates provide no fixed support point when they undergo twisting leftwards and rightwards so that the support points of the oscillation member move around the spring plates during the oscillation. Although the manufacturing cost is reduced, the locations of the support points for oscillation are not fixed, so that the rotation axis of the spring plates constantly changes and uncontrollability of the projection location becomes a major problem. In addition, assembling the spring plates at the two ends must be very precise for a slight angular deviation would make the rotational axes not on the same straight line so that the projection location is susceptible to shifting and variation, this being an additional drawback.

### SUMMARY OF THE INVENTION

The primary objective of the present invention is that an oscillation of an actuator is mounted, in a movable manner, on a base, and the base comprises an assembly opening formed in a central portion thereof, the assembly opening being provided with a positioning seat on each of at least one diagonal bisection line. The oscillation member that comprises an optical lens is supported on the base by two flexible members so as to form a suspension system of an optical actuator. The two flexible members are each a plate-like structure and has two opposite side edges each formed with a shaped trough with a portion therebetween forming a bridge, and two sides of the bridge are corresponding to tangential lines of positioning curves of the shaped troughs. Thus, when the flexible member of the suspension system are twisted, a support point of twisting can be constrained at a fixed position at a center of the bridge. This allows light passing through the actuator to oscillate in a very precise manner for each cycle of oscillation and the light can be projected to a desired location to thereby improving resolution and also lowering down cost, occupying less space, so as to overcome all the drawbacks of the prior art.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view illustrating the present invention in an assembled form.

FIG. 2 is an exploded view of the present invention that is embodied for single axis rotation.

FIG. 3-1 is a perspective view showing a first example of a flexible member of the present invention.

FIG. 3-2 is a plan view of the first example of the flexible member of the present invention. FIG. 4-1 is a perspective view showing a second example of the flexible member of the present invention.

FIG. 4-2 is a plan view of the second example of the flexible member of the present invention.

FIG. 5-1 is a perspective view showing a third example of the flexible member of the present invention.

FIG. 5-2 is a plan view of the third example of the flexible member of the present invention.

FIG. 6 is a plan view of the present invention that is embodied for single axis rotation.

FIG. 7 is a perspective view of the present invention that is embodied for dual axis rotation.

FIG. 8 is a plan view of the present invention that is embodied for dual axis rotation.

FIG. 9 is a schematic view illustrating an application of an optical actuator.

FIG. 10 is another schematic view illustrating an application of an optical actuator.

FIG. 11 is a perspective view illustrating a prior art optical actuator.

FIG. 12 is a plan view of FIG. 11.

FIG. 13 is a cross-sectional view taken along line A-A of FIG. 12.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

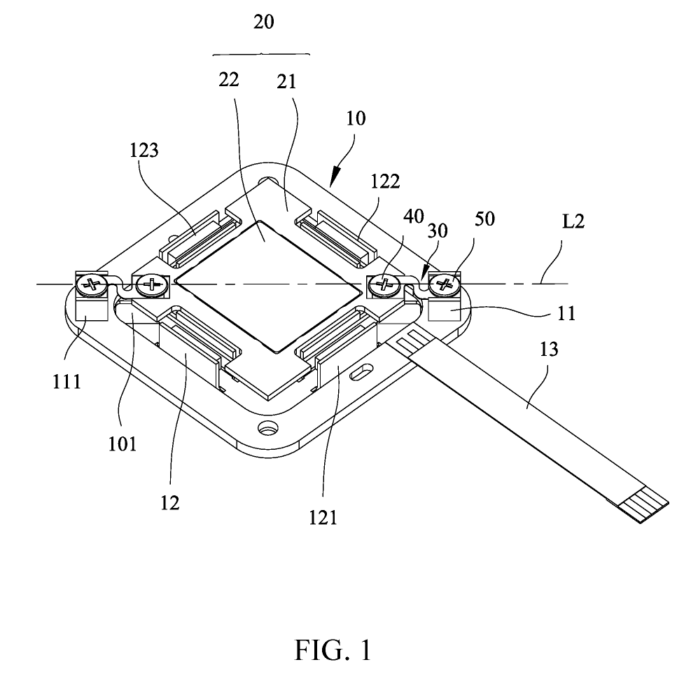

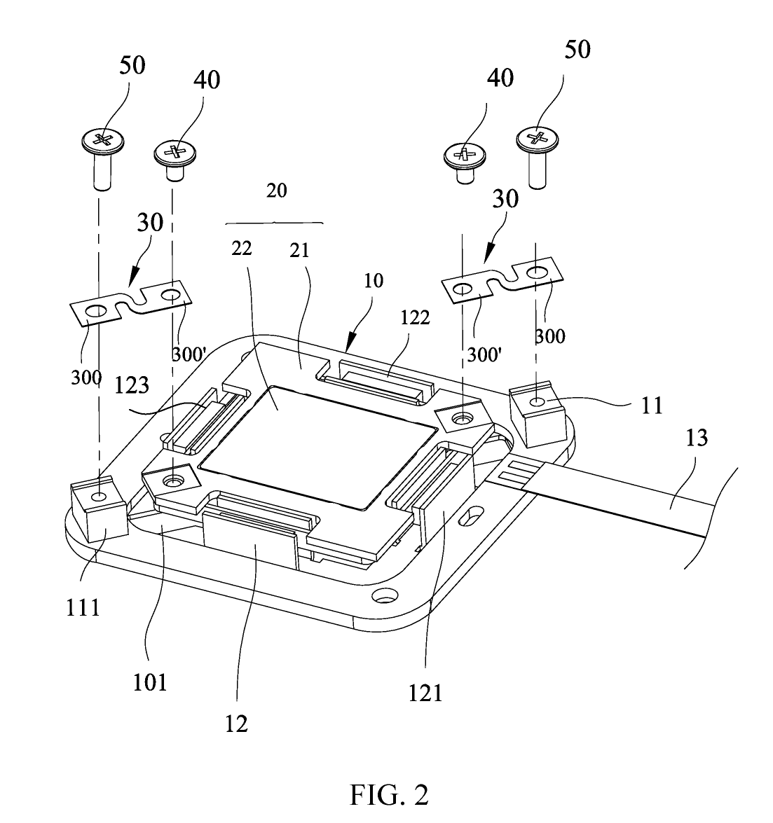

Referring to FIGS. 1 and 2, a suspension system of an optical actuator according to the present invention that is embodied for single axis rotation is illustrated, wherein an oscillation member 20 of an actuator is mounted, in a movable manner, on a base 10. The base 10 comprises a rectangular assembly opening 101 formed in a central portion thereof The assembly opening 101 is provided with positioning seats 11, 111 respectively at two opposite ends along a diagonal line thereof The assembly opening 101 is also provided, on sides thereof, with a plurality of magnetic devices 12, 121, 122, 123, and is additionally provided with a power cable 13 at one end thereof.

The oscillation member 20 is mounted above the assembly opening 101 of the base 10 and comprises a frame-like carrier platform 21 with an optical lens 22 embedded centrally therein.

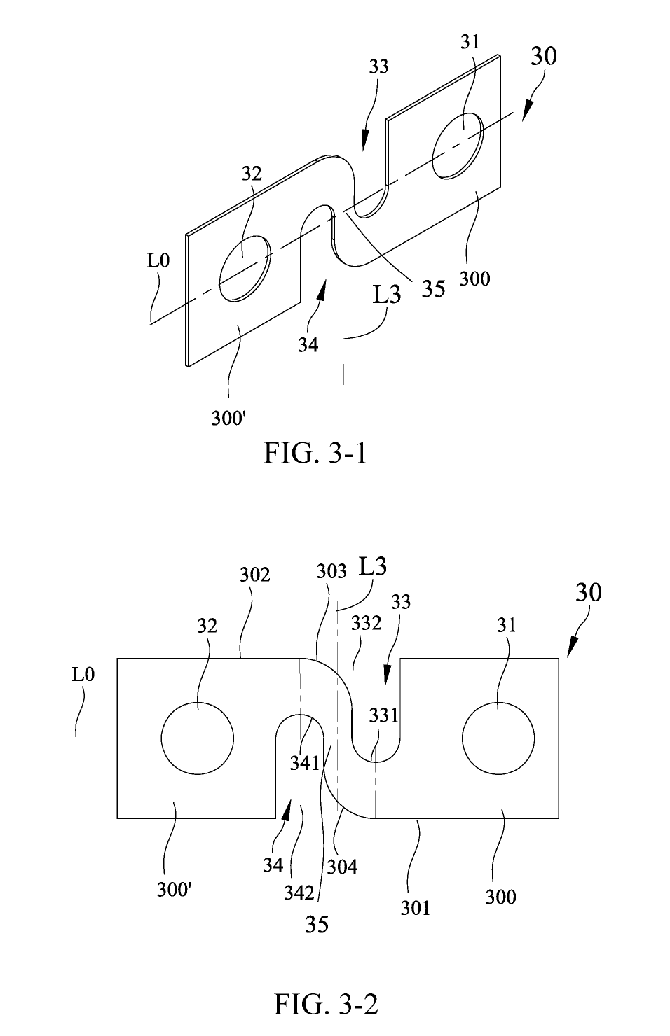

Referring to FIGS. 1, 2, 3-1, and 3-2, two flexible members 30 are arranged opposite to each other and are each a plate-like elongate structure that comprises two ends forming mounting sections 300, 300′, respectively, of which a preferred embodiment is such that each mounting section comprises a fixing hole 31, 32 with a longitudinal bisection line L0 of the flexible member 30 extending through and between the two fixing holes 31, 32; and a main body having two major, long, side edges 301, 302 each of which is recessed inwardly, in a direction toward a center of the main body, at a location close to a middle thereof to form a shaped trough 33, 34, such that the two shaped troughs 33, 34 are staggered with respect to or shifted away from each other to form a narrow bridge 35 between the two shaped troughs 33, 34 and a central portion of the flexible member 30 forms an S-shaped configuration. The two shaped troughs 33, 34 are each provided, as an edge thereof close to the bridge 35, with a positioning curve 331, 341, wherein the positioning curves 331, 341 can be arc curves of a circle, arc curves of an ellipse, or even curves of free curvatures and circular arc curves are taken as an example for illustration in the present invention. The two positioning curves 331, 341 are made tangential to each other, as being spaced by the bridge 35, so that the bridge 35 is located at the inflection point of the two positioning curves 331, 341. In the example illustrated in FIGS. 3-1 and 3-2, the curved sections of the two positioning curves 331, 341, which are in an arch form, face the two major side edges 301, 302 of the rectangular main body of the flexible member 30 and a tangential line L3 of the two positioning curves 331, 341, which extends through the bridge 35, is generally perpendicular to the longitudinal bisection line L0 of the flexible member 30 (meaning an included angle between the tangential line L3 and the longitudinal bisection line L0 of the flexible member 30 is 90 degrees). This description provides the structure of a first example of the present invention.

To make the flexible members 30 more flexible during flexing, trough mouths 332, 342 of the two positioning curves 331, 341 are each provided with an arc chamfer 303, 304, such that curves of the arc chamfers 303, 304 correspond, in curvature and location, to the positioning curves 331, 341 to provide the central portion of the flexible member 30 with better flexibility. Side edges of the trough mouths 332, 342 can be formed with notches of various shapes or sizes or even in a convergent or divergent form for consideration of various factors including strength and weight, this being not affecting the substantive scope of the present invention.

To use the present invention, referring to FIGS. 1, 2, and 6, two fastening members 40 are each set through the mounting section 300′ of one end of each of the two flexible members 30 and are respectively mounted to two opposite ends of the frame-like carrier platform 21 of the oscillation member 20. Two additional fastening members 50 are provided to be each set through the mounting section 300 of another end of each of the two flexible members 30 and fixed to the positioning seat 11, 111 of the base 10. As such, the oscillation member 20 is allowed to oscillate up and down with an axis L2 of two flexible members 30 as a center. As such in FIG. 1, when electrical power is supplied through the power cable 13 to energize the magnetic devices 12, 121, 122, 123 of the base 10, the oscillation member 20 is forced, with the axis L2 as an axis, to fast oscillate on the two sides and as such, as shown in FIGS. 6 and 3-1, a support point P is formed in the bridge 35 of each of the two flexible members 30 to support the oscillation of the oscillation member 20. The support point P is constrained by the two positioning curves 331, 341 that are arranged tangential to each other and is thus constrained at a fixed location without being easily shifted, whereby in each cycle of oscillation of the oscillation member 20, the rotation angle can be precisely set, making the light projection location of the actuator extremely precise and accurate, and stability of resolution being improved.

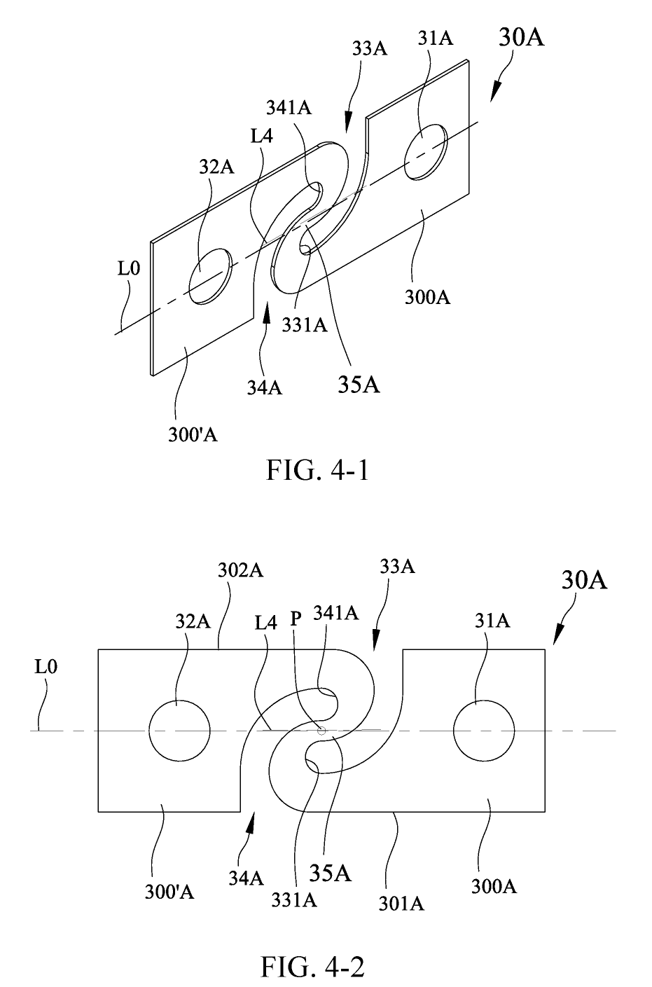

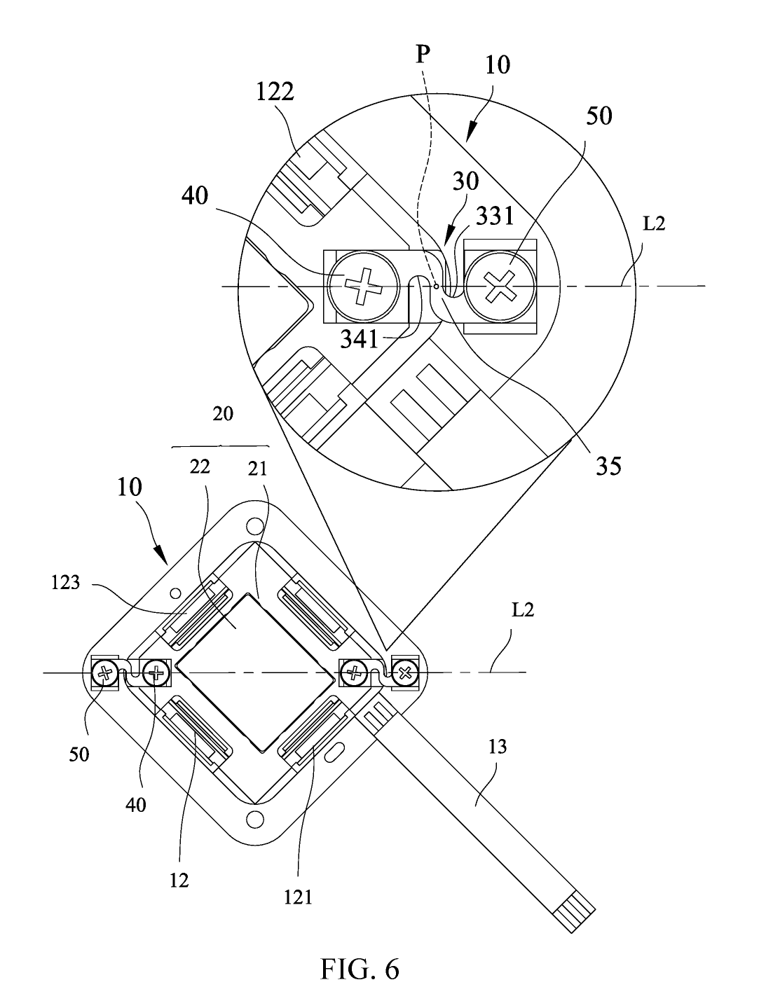

As a second example of the structure of the flexible members 30, FIGS. 4-1 and 4-2 provide two flexible members 30A that are arranged opposite to each other and are each a plate-like elongate structure that comprises two ends forming mounting sections 300A, 300′A, respectively, of which a preferred embodiment is such that each mounting section comprises a fixing hole 31A, 32A with a longitudinal bisection line L0 of the flexible member 30A extending through and between the two fixing holes 31A, 32A; and a main body having two major, long, side edges 301A, 302A each of which is recessed inwardly, in a direction toward a center of the main body, at a location close to a middle thereof to form a shaped trough 33A, 34A, such that the two shaped troughs 33A, 34A are staggered with respect to or shifted away from each other to form a narrow bridge 35A between the two shaped troughs 33A, 34A and a central portion of the flexible member 30A forms an S-shaped configuration. The two shaped troughs 33A, 34A are each provided, as an edge thereof close to the bridge 35A, with a positioning curve 331A, 341A, wherein the positioning curves 331A, 341A can be arc curves of a circle, arc curves of an ellipse, or even curves of free curvatures and circular arc curves are taken as an example for illustration in the present invention. The two positioning curves 331A, 341A are made tangential to each other, as being spaced by the bridge 35A, so that the bridge 35A is located at the inflection point of the two positioning curves 331A, 341A. A tangential line L4 of the two positioning curves 331A, 341A, which extends through the bridge 35A, is coincident with the longitudinal bisection line L0 of the flexible member 30A (meaning an included angle between the tangential line L4 and the longitudinal bisection line L0 of the flexible member 30A is 0 degree). This arrangement makes the shaped troughs 33A, 34A that are located between two mounting sections 300A, 300′A of the flexible member 30A further extended and longer and showing a curved configuration about a center defined by the bridge 35A, so that when the flexible member 30A is flexing (in the condition of FIGS. 1 and 6), a better effect of flexing is achieved, while the support point P is constrained at a fixed position in the center of the bridge 35A.

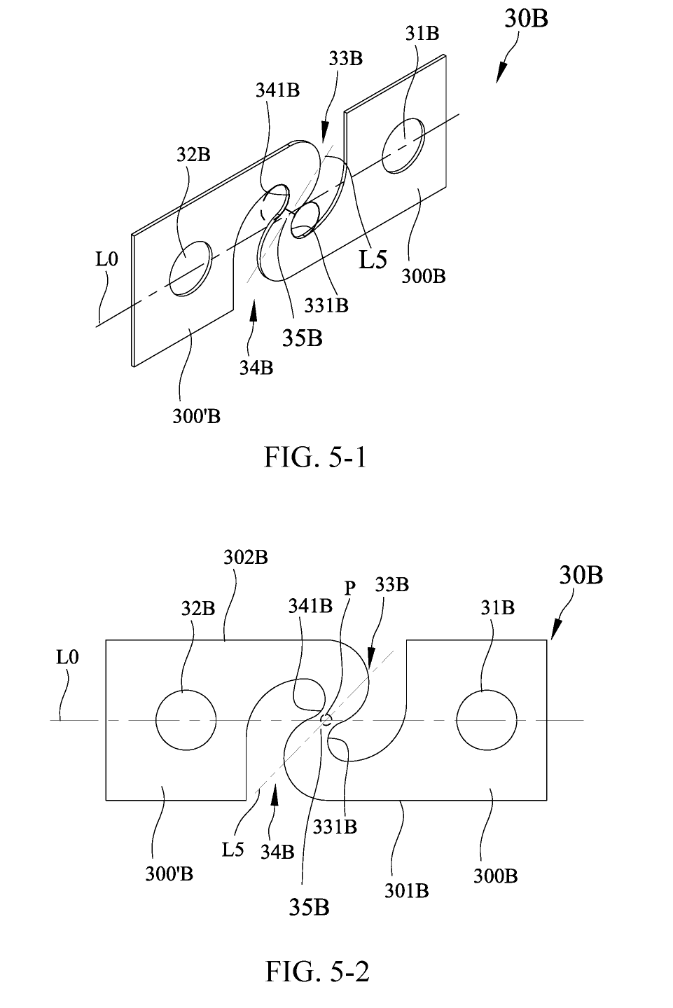

Referring to FIGS. 5-1 and 5-2, flexible members 30B of a third example according to the present invention are shown. Two flexible members 30B are arranged opposite to each other and are each a plate-like elongate structure that comprises two ends forming mounting sections 300B, 300′B, respectively, of which a preferred embodiment is such that each mounting section comprises a fixing hole 31B, 32B with a longitudinal bisection line L0 of the flexible member 30B extending through and between the two fixing holes 31B, 32B; and a main body having two major, long, side edges 301B, 302B each of which is recessed inwardly, in a direction toward a center of the main body, at a location close to a middle thereof to form a shaped trough 33B, 34B, such that the two shaped troughs 33B, 34B are staggered with respect to or shifted away from each other to form a narrow bridge 35B between the two shaped troughs 33B, 34B and a central portion of the flexible member 30B forms an S-shaped configuration. The two shaped troughs 33B, 34B are each provided, as an edge thereof close to the bridge 35B, with a positioning curve 331B, 341B, wherein the positioning curves 331B, 341B can be arc curves of a circle, arc curves of an ellipse, or even curves of free curvatures and circular arc curves are taken as an example for illustration in the present invention. The two positioning curves 331B, 341B are made tangential to each other, as being spaced by the bridge 35B, so that the bridge 35B is located at the inflection point of the two positioning curves 331B, 341B. A tangential line L5 of the two positioning curves 331B, 341B, which extends through the bridge 35B, forms an included angle of 45 degrees with respect to the longitudinal bisection line L0 of the flexible member 30B. Although an angle of 45 degrees is illustrated in the example of FIGS. 5-1 and 5-2, for consideration of strength or flexibility of the bridge 35B, the included angle between the tangential line L5 of the two positioning curves 331B, 341B and the longitudinal bisection line L0 at the center of the flexible member 30B can be varied, such as 30 degrees, 45 degrees, 60 degrees, or any angle between 0 degree and 90 degrees, provided the bridge 35B is located on a tangential line of the two positioning curves 331B, 341B so that when the flexible member 30B is flexing (in the condition of FIGS. 1 and 6), besides a better effect of flexing being achieved, the support point P can be constrained at a fixed position in the center of the bridge 35B.

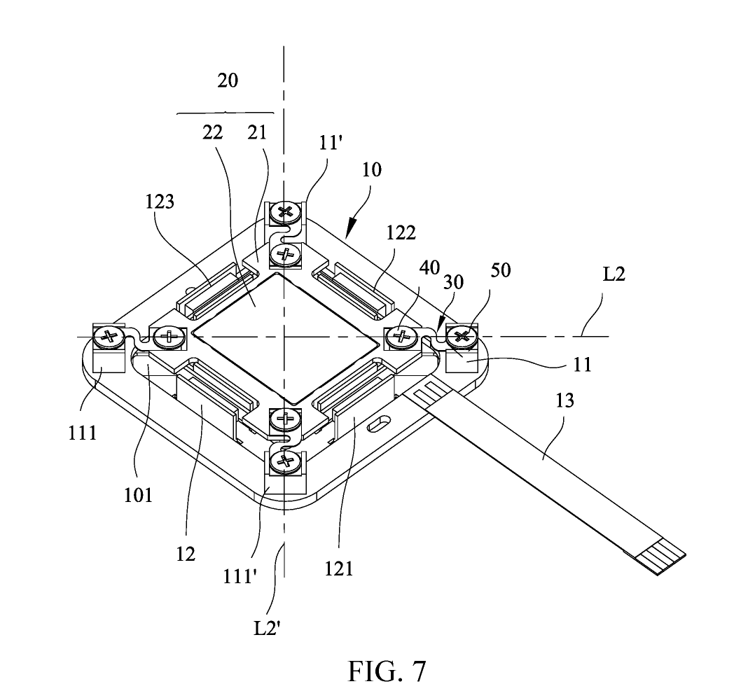

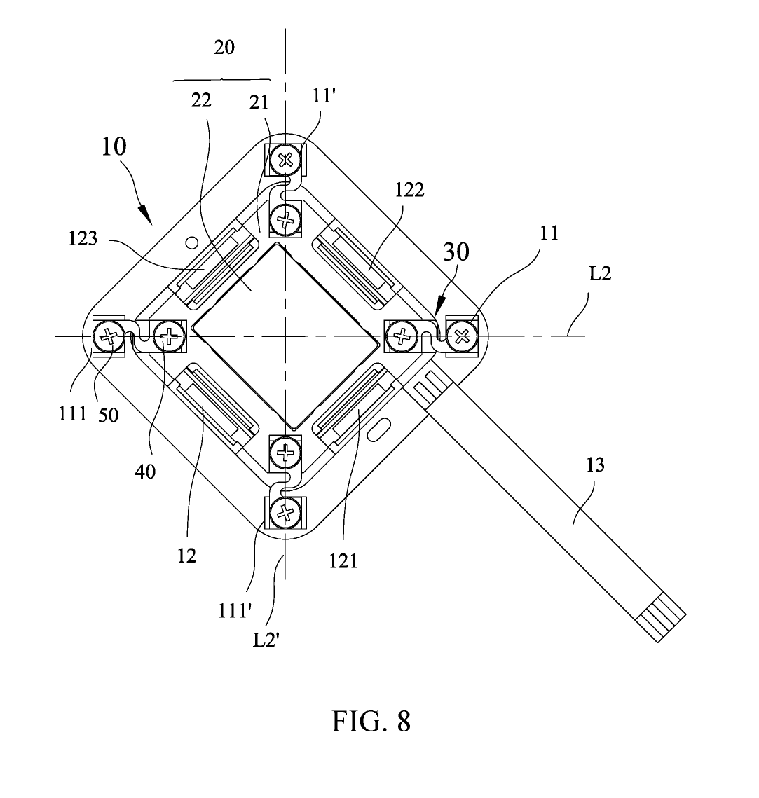

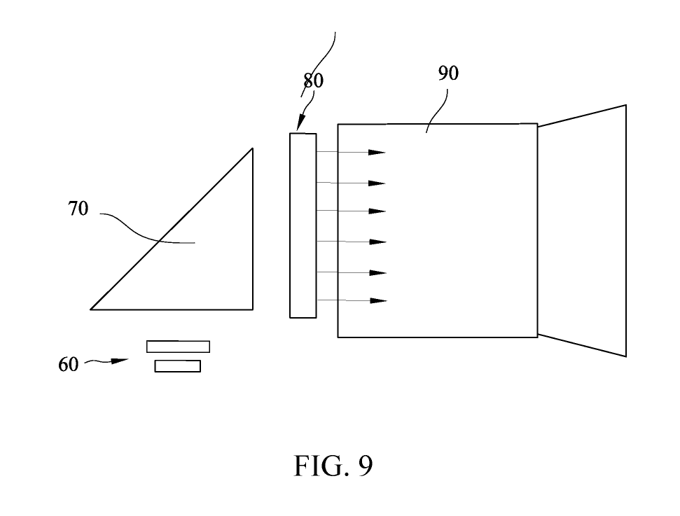

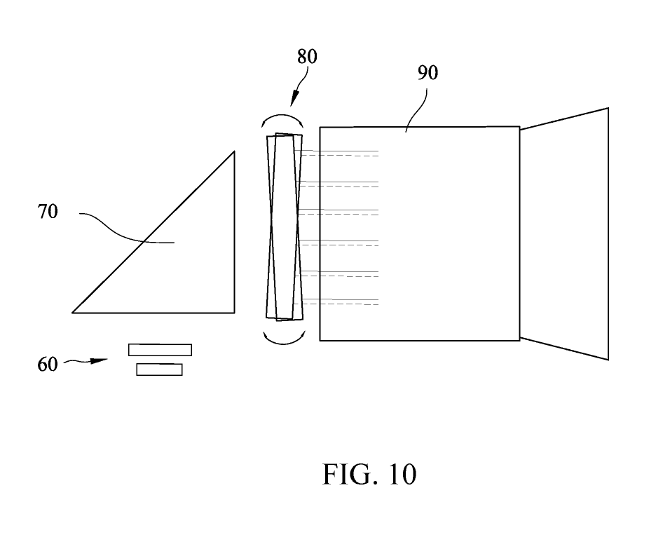

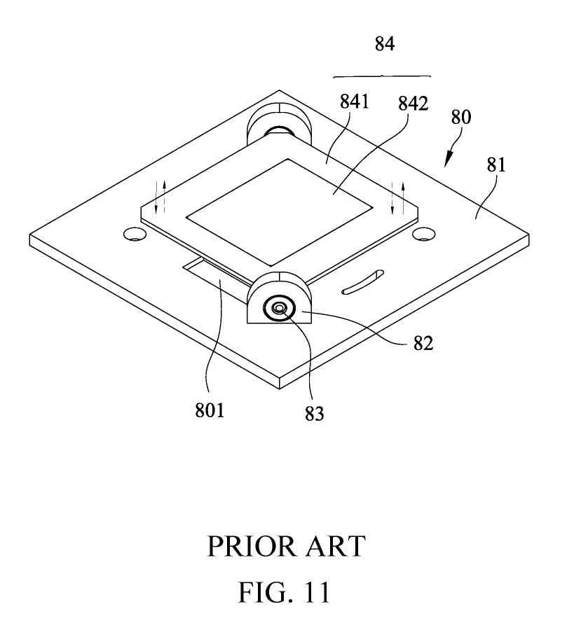

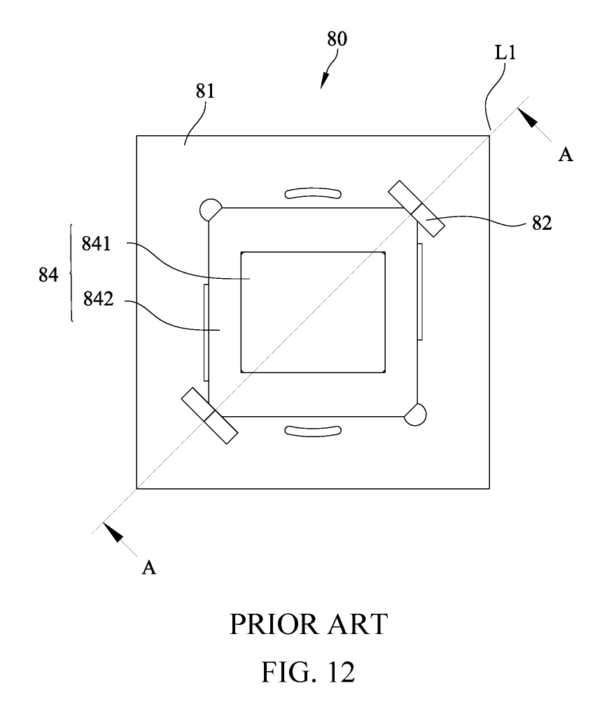

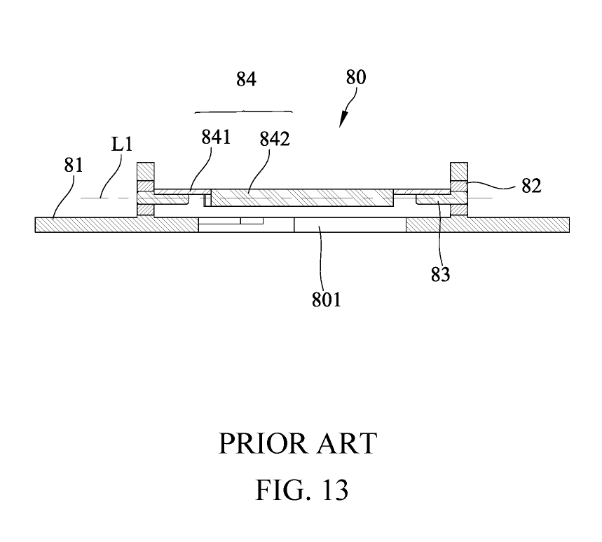

Referring to FIGS. 7 and 8, a suspension system of an optical actuator according to the present invention embodied for dual axis rotation is illustrated, wherein an oscillation member 20 of an actuator is mounted, in a movable manner, on a base 10. The base 10 comprises a rectangular assembly opening 101 formed in a central portion thereof. The assembly opening 101 is provided with positioning seats 11, 111, 11′, 111′ respectively at four corners of the assembly opening 101, namely two ends of two diagonal lines of the rectangle are each provided with one positioning seat 11, 111, 11′, 111′. The assembly opening 101 is also provided, on sides thereof, with a plurality of magnetic devices 12, 121, 122, 123, and is additionally provided with a power cable 13 at one end thereof.

The oscillation member 20 is mounted above the assembly opening 101 of the base 10 and comprises a frame-like carrier platform 21 with an optical lens 22 embedded centrally therein.

Four flexible members 30, 30A, 30B, which can be ones illustrated in FIGS. 3-1 and 3-2, or those illustrated in FIGS. 4-1 and 4-2, or those illustrated in FIGS. 5-1 and 5-2, are arranged as two groups each including two such flexible members opposite to each other. Taking the structure shown in FIGS. 3-1 and 3-2 as an example, with additional reference being had to FIGS. 7 and 8, four fastening members 40 are each set through the mounting section 300′ of one end of each of the four flexible members 30 and are fixed to corresponding ends of the frame-like carrier platform 21 of the oscillation member 20. Four additional fastening members 50 are provided to be each set through the mounting section 300 of another end of each of the four flexible members 30 and fixed to the positioning seat 11, 111, 11′, 111′ of the base 10. As such, the oscillation member 20 is allowed to oscillate up and down, in different directions, with two axes L2, L2′ of the two groups of flexible members 30 as centers. Thus, when electrical power is supplied through the power cable 13 to energize the magnetic devices 12, 121, 122, 123 of the base 10, the oscillation member 20 is forced to have four ends thereof fast oscillate in a regular manner, with the two axes L2, L2′ as axes with time difference therebetween, so as to provide projection of better resolution and stability.

The present invention comprises two flexible members mounted on a base to form a suspension system for an optical actuator, wherein the flexible members are each formed, at two side edges thereof, with shaped troughs with a bridge provided therebetween, such the bridge is located at the inflection point of curves of the two shaped troughs, whereby when the flexible member of the suspension system is twisted, a support point for the twisting is constrained at a fixed position at a center of the bridge so that light from the actuator can be set extremely precise for each cycle of oscillation and the light can be projected onto a desired predetermined location and thus improving resolution.

The present invention involves a design that is based on thin plate and this is of low design cost and allows for easy removal and replacement. Materials can be selected to meet the requirement so the selection of material is of great flexibility. The size can also be reduced, making it not occupy excessive space and thus favorable for management of warehousing.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A suspension system of an optical actuator, in which an oscillation member of an actuator is mounted, in a movable manner, on a base, and the base comprises an assembly opening formed in a central portion thereof, the assembly opening being provided with a positioning seat on each of at least one diagonal bisection line, the assembly opening being provided, on sides thereof, with a plurality of magnetic devices, and a power cable at an end thereof;
wherein the oscillation member is mounted above the assembly opening of the base comprises a frame-like carrier platform with an optical lens embedded centrally therein;
two flexible members are arranged opposite to each other and are each a plate-like elongate structure that comprises two ends forming mounting sections and a main body having two major side edges each of which is recessed inwardly in a direction toward a center of the main body, at a location close to a middle thereof to form a shaped trough such that the two shaped troughs are staggered with respect to each other to form a narrow bridge between the two shaped troughs, two shaped troughs being each provided, as an edge thereof close to the bridge, with a positioning curve, the two positioning curves being made tangential to each other as being spaced by the bridge so that the bridge is located at an inflection point of the two positioning curves;
two fastening members are respectively attached to the two flexible members at one end thereof for fixing to two opposite ends of the frame-like carrier platform of the oscillation member, two additional fastening members being respectively attached to the two flexible members at an opposite end thereof for fixing to the positioning seats of the base so that the oscillation member is allowed to oscillate toward two sides with an axis between the two flexible members as a center;
when electrical power is supplied through the power cable to energize the magnetic devices mounted on the base, the oscillation member is caused to generate fast oscillation on two sides with the axis as an axis, where a fixed support point is formed on the bridge of each of the two flexible members to support the oscillation of the oscillation member thereby making light projection precise.

2. The suspension system of the optical actuator according to claim 1, wherein the positioning curves of the flexible members are one of an arc curve of a circle, an arc curve of an ellipse, and a curve of free curvatures.

3. The suspension system of the optical actuator according to claim 1, wherein curved sections of the positioning curves of the shaped troughs on the two side edges of each of the flexible members are in an arch form facing the two major side edges of the elongate main body and the two positioning curves have a tangential line in the bridge and perpendicular to a longitudinal bisection line of the flexible member.

4. The suspension system of the optical actuator according to claim 1, wherein the positioning curves of the shaped troughs on the two side edges of each of the flexible members have a tangential line in the bridge and coincident with a longitudinal bisection line of the flexible member.

5. The suspension system of the optical actuator according to claim 1, wherein the positioning curves of the shaped troughs on the two side edges of each of the flexible members have a tangential line in the bridge and forming an included angle with respect to a longitudinal bisection line of the flexible member, which angle is between 0 degree and 90 degrees.

6. The suspension system of the optical actuator according to claim 1, wherein the shaped troughs on the two side edges of each of the flexible members show a curved configuration about a center defined by the bridge.

7. The suspension system of the optical actuator according to claim 1, wherein the shaped troughs that are formed, in a manner of being recessed toward each other, between the two mounting sections of each of the flexible members and the bridge that is formed in the middle, in a narrowed form, collectively define an S-shaped configuration.

8. The suspension system of the optical actuator according to claim 1, wherein the positioning curves on the two side edges of each of the flexible members are each provided with a trough mouth that is provided with a chamfer and is formed with extended notches.

9. The suspension system of the optical actuator according to claim 1, wherein the mounting sections on two opposite ends of each of the flexible members are each provided with a fixing hole.

10. A suspension system of an optical actuator, in which an oscillation member of an actuator is mounted, in a movable manner, on a base, and the base comprises an assembly opening formed in a central portion thereof, the assembly opening being provided with a positioning seat on each of four corners of the assembly opening such that two opposite ends of each of two diagonal lines are each provided with one of the positioning seats, the assembly opening being provided, on sides thereof, with a plurality of magnetic devices, and a power cable at an end thereof;
wherein the oscillation member is mounted above the assembly opening of the base and comprises a frame-like carrier platform with an optical lens embedded centrally therein;
four flexible members are arranged as two groups each including two such flexible members opposite to each other and are each a plate-like elongate structure that comprises two ends forming mounting sections and a main body having two major side edges each of which is recessed inwardly in a direction toward a center of the main body, at a location close to a middle thereof to form a shaped trough such that the two shaped troughs are staggered with respect to each other to form a narrow bridge between the two shaped troughs, two shaped troughs being each provided, as an edge thereof close to the bridge, with a positioning curve, the two positioning curves being made tangential to each other as being spaced by the bridge so that the bridge is located at an inflection point of the two positioning curves;
four fastening members are respectively penetrated through the mounting sections of the four flexible members at one end thereof for fixing to opposite ends of the frame-like carrier platform of the oscillation member, four additional fastening members being respectively penetrated through the mounting sections of the four flexible members at an opposite end thereof for fixing to the positioning seats of the base so that the oscillation member is allowed to oscillate up and down in different direction with two axes between the flexible members of the two groups as centers;
when electrical power is supplied through the power cable to energize the magnetic devices of the base, the oscillation member is forced to have four ends thereof fast oscillate in a regular manner, with the two axes as axes with time difference therebetween, so as to provide projection of better resolution and stability.

11. The suspension system of the optical actuator according to claim 10, wherein the positioning curves of the flexible members are one of an arc curve of a circle, an arc curve of an ellipse, and a curve of free curvatures.

12. The suspension system of the optical actuator according to claim 10, wherein curved sections of the positioning curves of the shaped troughs on the two side edges of each of the flexible members are in an arch form facing the two major side edges of the elongate main body and the two positioning curves have a tangential line in the bridge and perpendicular to a longitudinal bisection line of the flexible member.

13. The suspension system of the optical actuator according to claim 10, wherein the positioning curves of the shaped troughs on the two side edges of each of the flexible members have a tangential line in the bridge and coincident with a longitudinal bisection line of the flexible member.

14. The suspension system of the optical actuator according to claim 10, wherein the positioning curves of the shaped troughs on the two side edges of each of the flexible members have a tangential line in the bridge and forming an included angle with respect to a longitudinal bisection line of the flexible member, which angle is between 0 degree and 90 degrees.

15. The suspension system of the optical actuator according to claim 10, wherein the shaped troughs that are formed, in a manner of being recessed toward each other, between the two mounting sections of each of the flexible members and the bridge that is formed in the middle, in a narrowed form, collectively define an S-shaped configuration.
